(19) United States
(12) Patent Application Publication
(10) Pub. No.: US 2014/0170629 A1
(43) Pub. Date: Jun. 19, 2014

(54) PRODUCING CONTROLLED VARIATIONS IN AUTOMATED TEACHING SYSTEM INTERACTIONS

(71) Applicant: Rosetta Stone, Ltd., Harrisonburg, VA (US)

(72) Inventors: Gregory Keim, Broadway, VA (US); Ronald Bryce Inouye, Harrisonburg, VA (US); Karl Ridgeway, Boulder, CO (US); Robin Smith, Harrisonburg, VA (US); Kyle Kuhn, Harrisonburg, VA (US); Jack Marmorstein, Harrisonburg, VA (US); Brian Vaughn, Harrisonburg, VA (US); Alisha Huber, Dayton, VA (US)

(73) Assignee: Rosetta Stone, Ltd., Harrisonburg, VA (US)

(21) Appl. No.: 14/101,073

(22) Filed: Dec. 9, 2013

Related U.S. Application Data
(63) Continuation of application No. PCT/US2011/048226, filed on Aug. 18, 2011.
(60) Provisional application No. 61/520,390, filed on Jun. 9, 2011.

(51) Int. Cl. G09B 19/06

(52) U.S. Cl. CPC G09B 19/06
USPC 434/362

(57) ABSTRACT

The content of an instructor-student interaction set in an automated teaching system is represented in a graph-based format. In a graph-based representation, not only can variations branch away from each other at a node (branching point), as in the tree-based representation, but they can also merge back together. Not only does this make the -structure more compact, but it increases the number of variations that can be represented in the content while simultaneously eliminating the need to individually author each variation.

### BACKGROUND OF THE INVENTION

The present invention relates generally to automated teaching systems and, more particularly, concerns a method and apparatus for producing controlled variations in interactions with a student utilizing an automated teaching system.

For convenience of description, the invention will be presented in the context of an automated language instruction apparatus. However, those skilled in the art will appreciate that the invention is equally applicable to any type of automated teaching system.

Many of the problems encountered with automated teaching systems are exemplified by systems that are intended to teach a student a language. To some extent, the problems arise from using traditional teaching methods rather than taking full advantage of the processing power available in automated systems. For example, the traditional technique for teaching a language basically involves interaction between an instructor and a student by following a script. The instructor (or teaching machine) makes statements, and the student is expected to respond to them in some predetermined way. Although the traditional scripting technique offers some pedagogical benefits, it suffers from a number of shortcomings. First of all, a student can succeed in completing a scripted dialogue by memorization, with little or no comprehension. Secondly, such practice quickly becomes repetitive and boring, as the task changes little from one time to the next. Loss of student interest is a very serious shortcoming. From the point of view of an automated system, the traditional technique also suffers from the shortcoming that it becomes necessary for a programmer to author each script.

In an effort to deal with the shortcomings of the scripting technique, teaching machines have utilized a tree-based data structure to introduce variation to instructor-student interactions. Basically, the data is structured like an inverted tree, with an interaction occurring at each branching point (node). The range of allowable student responses is still memorized and finite, but the branching can vary from session to session.

While tree-based control allows substantial flexibility in the ability to present new variations of computer-student interactions, tree-based representations are cumbersome to construct and maintain. Each variation must be separately constructed. Variations generated by branching points far down the tree share a common sub-sequence up to the branching point, so the degree of variation may not be great for many of the interactions.

Also, variations that share a common sub-sequence at the end cannot be represented compactly. More generally, although tree-based representations capture common prefixes of S the scripts that make up its content, they offer little benefit if the variation occurs in the beginning or the middle of a set of scripts that share a common ending. Also, each possible variation that the student might see must ultimately be encoded explicitly in the tree. Thus, tree-based control, while useful, is not powerful enough to provide the types of variations that are needed for the most effective teaching. These variations include:
re-ordering of sub-sequences of an interaction sequence;
optional inclusion/omission of sub-sequences of an interaction sequence;
semantically stable rewording of instructor prompts (for language instruction);
variable substitution in student responses; and
change in non-linguistic context (for language instruction).

There is therefore a need in the art for an effective process for creating controlled variations in automated teaching system interactions. Ideally, there should be high variability in the number of unique communications from the computer teaching system, while the number of unique student responses should be relatively low. From a pedagogical point of view in language instruction, this will make the student able to communicate interactively as quickly as possible. From a technical point of view, this eases the processing burden on the system. For example, if voice recognition were being used to sense the student's responses, it would be desirable to minimize the number of student utterances that would have to be recognized.

Another problem in the prior art relates to systems in which a live instructor is introduced for further practice after a student uses computer software for an initial learning stage. The curriculum taught introduced during the computer software phase often is largely independent of the live instruction that will occur. This leads to an inefficiency in that the student may not be receiving optimum instruction in the most efficient manner.

In accordance with one aspect of the present invention, the content of a computer student interaction set in an automated teaching system is represented in a graph-based format, including nodes and paths. In a graph-based representation, not only can variations branch away from each other at a node, as in the tree-based representation, but they can also merge back together by permitting more than one higher level nodes to branch into a node. Not only does this make the structure more compact, but it increases the number of variations that can be represented in the content while simultaneously eliminating the need to individually author each variation.

In accordance with another aspect of the present invention, the number of variations expressible by a graph is increased without increasing the size of the graph by utilizing specially processed node groups and types of nodes. These include serial groups which are processed precisely in series, AND-groups in which all of the constituents are processed in random order, before proceeding to a lower group, XOR-groups in which only one of the constituents is processed. before proceeding to a lower group, and optional nodes which can be controlled to have their processing inhibited.

In accordance with another aspect of the present invention, the number of different possible student responses can be significantly increased, without increasing the cognitive load on the student, by introducing a template/variable structure to the student response set. This involves forming a statement as a fixed template in which different subject matter can be introduced at one or more locations as a variable.

In accordance with still another aspect of the invention, the computer software doing the instruction has advance knowledge of one or more options for a teaching curriculum that will be executed during an upcoming live instruction session. To optimize use of the live instruction session, the computer determines which nodes and paths should be practiced and/or taught during the computer teaching session. Based upon a variety of specific factors detailed further herein, some of which may be user specific and some of which may be system wide, the computer selects nodes and paths to teach so that a live instruction session to follow is optimized.

The method may also involve the computer selecting one of plural possible live instruction sessions to be executed during an upcoming live session.

### BRIEF DESCRIPTION OF THE DRAWINGS

The foregoing brief description and further objects, features and advantages of the present invention will be understood more completely from the following detailed description of a presently preferred, but nonetheless illustrative, embodiment in accordance with the present invention, with reference being had to the accompanying drawings in which:

FIG. 1 is a block diagram illustrating a graph 10 representing the structure of an instructor-student interaction set embodying the invention, on which a student might be trained;

FIG. 2 is a flowchart illustrating a student task selection process in accordance with an aspect of the invention; and

FIG. 3 is a block diagram illustrating graph 10 of FIG. 1 after a substantial amount of instruction has been provided to the student.

### DETAILED DESCRIPTION

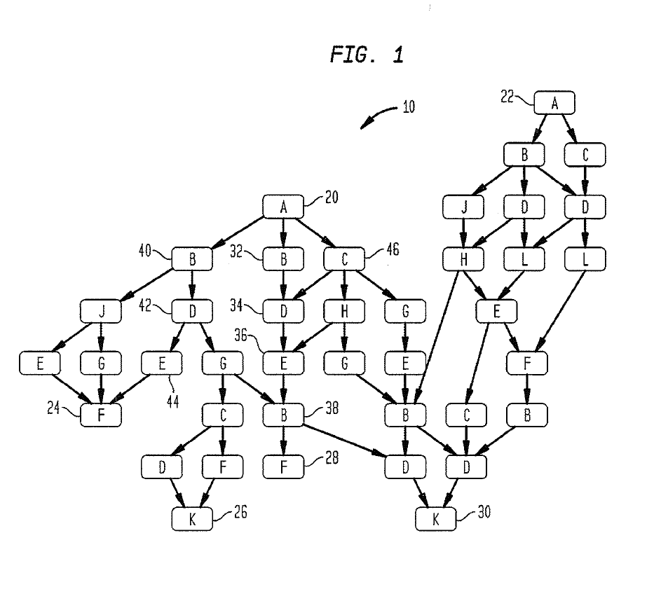

As already explained, in accordance with one aspect of the present invention, the content of an interaction set is represented in a graph-based structure. FIG. 1 is a block diagram illustrating a graph 10 representing the structure of an instructor-student interaction set on which a student might be trained. Each rectangle in the graph is a node, which, in the preferred embodiment, represents a single interaction constituting an instructor (human or computer) communication followed by a student response.

Although, for simplicity of disclosure, each node is a single interaction in the preferred embodiment, in practice, it may be arbitrarily complex. For example, it may represent a subdialogue, such as a clarification, or asking someone to repeat something, or it could represent an entire subgraph representing a sub-lesson, or the like.

For purposes of explanation, it will be assumed that the student is receiving training in speaking a language by computer, and that interaction will consist of an utterance by the computer followed by an utterance by the student. Additionally, such instruction is to be followed preferably by live instruction, in which a student interacts with a live instructor.

The letter appearing in each node rectangle represents the content of the student's utterance. In nodes that contain the same letter, the student's utterance is the same, although the instructor's utterance may differ. As can be seen, the graph contains branches away from a node in the same manner as in a tree, but it also contains branches back into a node as a result of more than one higher level node branching into a node.

In addition, use will be made of SERIAL-groups, AND-groups, XOR-groups and optional nodes to increase the number of variations expressible by a graph without increasing the size of the graph.

A SERIAL-group is a sequence of graph nodes that have a sequential linear relationship. They represent a section of interaction that is scripted with no variation. Such groups do not provide expressive power in and of themselves, but they exist to group nodes together for use elsewhere.

An AND-group is a set of nodes or groups at the same level (sibling nodes or groups) which, when encountered, are all performed before proceeding to a lower-level. The order in which the constituents of the AND-group are performed is selected at random.

An XOR-group is a set of sibling nodes and/or groups of which only one is performed when the group is encountered.

An optional node has some probability of not being performed when encountered (decided either globally, per node, or per student).

By employing a graph structure with the special nodes and groups described above, it becomes possible to obtain compact representation of an interaction space comprising thousands of possible variations. The relatively small size of the data structure makes it possible to do authoring and editing of the content in a fraction of the time it would take to produce and maintain that many variations by hand.

An important goal is to require students to memorize a relatively small set of responses. The primary task of the student is then to attend to what the instructor is saying and to decide in a timely fashion which of the allowable responses is appropriate for the given situation.

The number of different possible student responses can be significantly increased, without increasing the cognitive load on the student by introducing a template/variable structure to the response set. Some or all of the student's responses may have sections which can be replaced by a variety of alternatives. For example, in a particular interaction set a student may be allowed the response “I'm planning on going to the store tomorrow.” Given different situations in the same interactions set, the student's response might instead be “I'm planning on going to the office tomorrow” or “I'm planning on going to the beach tomorrow.” In this case, “I'm planning on going to X tomorrow” is the template, and “X” is the variable, which may take on the values “the store”, “the office”, “the beach.” As long as the correct value of the variable is clearly communicated, it is possible to generate many more variations of the student's response without significantly increasing the amount of material the student must memorize.

A distinction is made between two different modes of interaction: rehearsal and performance, which serve different pedagogical purposes. Rehearsal mode serves to train the student in the set of possible utterances in the interaction set. This can be an end in and of itself, and the content set may exist purely to assist the student to memorize a set of stock phrases to use in particular situations. In rehearsal mode, a Content Sequencing Processor (CSP) in the system decides, based on a predictive model, which student utterance should be trained, based on the probability that the student will be able to perform a specified task with that utterance. Possible tasks include, but are not limited to, one or a combination of the following, listed in decreasing order of difficulty:
1. oral production of the utterance in response to an instructor prompt designed to elicit specifically that utterance, where the student has not previously encountered the instructor prompt before;
2. oral production of the utterance in response to an instructor prompt designed to elicit specifically that utterance, where the student has previously encountered the utterance associated with the given instructor prompt before;
3. repetition of the utterance after hearing a recording of a native speaker saying the utterance;
4. reading the utterance out loud when presented with the text of the utterance on-screen; and
5. saying the utterance in pieces (a word or a few words at a time), prompted by a recording of a native speaker saying each piece and/or the text of each piece being displayed on-screen.

The goal of the training is to increase the probability that the student will be able to accomplish task (1) for each utterance. That is, given a dialogue situation in which only one student utterance of the set of utterances in the conversation set is appropriate, the student should be able to recognize which utterance to use, and to produce it acceptably in a timely fashion. To this end, the CSP presents the student with tasks for each utterance that are at the current extent of the student's ability to perform on that utterance.

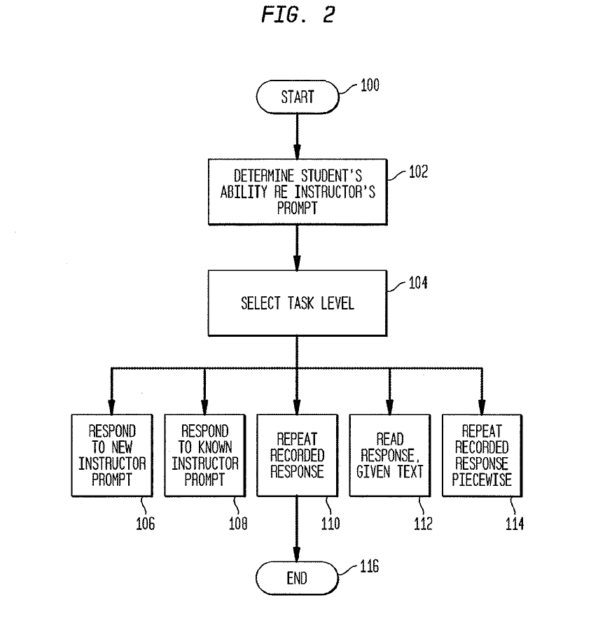

This task selection process of the CSP is illustrated in flowchart form in FIG. 2. The process stars at block 100, and at block 102 the CSP determines the student's ability with respect to the instructor's prompt. Typically, this would be done from store of information which maps the student's progress as he is being trained. Based on this determination, the task level is selected at block 104 from the above listing of five task levels, as abbreviated in blocks 106-114, respectively. Once the appropriate task selection is made from one of blocks 106-114, the selection process ends at block 116.

For example, initially, the CSP might ask the student to read. an utterance, given the text on-screen (block 112), because there is a high probability of the student being able to perform that task, whereas he would have close to zero probability of his being able to produce the exact utterance given only an instructor prompt designed to elicit that utterance. In a subsequent task selection, the student might be required to repeat the utterance given an audio recording of a native speaker saying the utterance (block 110). As the student is exercised in more difficult tasks, the probability increases that he will be able to produce the utterance in response to an instructor prompt, eventually to the point where the CSP estimates that the student has a high enough probability of succeeding at that task that it is reasonable to ask the student to do so.

The preceding discussion describes how the CSP determines which tasks to present to the student to train the student in the use of a specific utterance in a conversation set. The CSP is also responsible for determining which utterances to train, and in what order. These decisions are driven by the student's anticipated need to employ the utterances in a dialogue. Such dialogues can take place in two settings, in a human-computer interaction, or a human-human interaction.

Ultimately, it is desirable to train students to interact in dialogue with other humans in the target language. Human-computer dialogues are used as a low-cost means of training the student in performing such dialogues. Additionally, using a computer as the instructor in a dialogue makes it possible for the CSP to have greater control over what content the student sees, so that his performances can be designed to have the maximal training impact. A further benefit of using human-computer dialogues for training is that students may experience less anxiety in practicing with a machine than with a human native speaker of the language they are studying.

Based on when the student's next dialogue will happen, and the anticipated content of that dialogue, the CSP prioritizes the training of the student utterances in order to maximize the probability that the student will succeed at the dialogue when he participates in it.

Periodically in the course of the student's training in a conversation set, the student is presented with opportunities to interact in a dialogue setting with a human instructor. The instructor has an interface with which the CSP interacts to serve up content for the instructor to present to the student. The CSP selects content based on its knowledge of the training state of the student on the conversation set.

There are several possible modes in which the instructor may interact with the student.

The basic interaction is one in which the instructor is playing the role(s) played by the computer in the automated training. The CSP generates a dialogue for the student to play through, presents the content for the instructor to read, and the instructor drives the interaction through the interface. The instructor may also play similar roles or interact with similar dialogue as the computer, but vary it slightly.

During the live conversation with the instructor, the student sees essentially the same information that he sees when practicing with the computer, or information that is similar to it. Because of the integration between the human dialogue environment and the computer dialogue training environment, a student is able to practice his dialogue skills in a cost-efficient manner before actually interacting with a human instructor. He arrives with confidence in his abilities to perform the dialogue tasks which the instructor presents, and a familiarity with the content in which he will be asked to engage.

For some learning applications, a live-instructor environment in which the content never deviates significantly from the variations capable of being generated and presented in the software training dialogue interface is sufficient. For others, however, the end goal is to enable students to be able to handle a greater variety of situations than can be efficiently authored, modeled, and presented in that interface. The live instructor dialogue interface allows the human instructor to generate his own variations on the dialogues in the conversation set, building upon the training base already present. The CSP provides information to the instructor about what content is familiar to the student, and the level of ability to perform on individual pieces of content. The CSP? may also generate content other than that presented by the computer.

A rich content model has been developed which is capable of generating a vast array of student experiences that resemble each other but that pose novel challenges to students upon each encounter. The number of possible variations is great enough that a CSP is needed to select which content variations should be presented to the student at any given moment.

The CSP preferably takes into account a number of factors when determining which variation to present. The goal in this selection process is to determine which path(s) through the graph should be emphasized in order to maximize the chance that the live instruction will be match to what has just been taught by the computer and that the user is fully prepared by the time the live instruction occurs. Parameters that may be at issue include:
1. projected amount of time left in current computer training session
2. projected amount of time left in overall training for the current conversation set
3. observed knowledge of the student
4. predicted knowledge of the student
5. observed ability of the student
6. predicted ability of the student
7. available content in upcoming live instruction, (i.e.; the possible options for live instruction)
8. predicted maximum rate of content mastery by student

The task of the CSP at any given time is to determine what content to present to the student in order to present a manageable challenge that moves the student along towards an intermediate goal, given the knowledge and ability of the student, and matches the student to upcoming live content. Most often, the CSP will use a combination of the above criteria.

We will now return to the block diagram of an interaction set in FIG. 1 to demonstrate how the CSP controls student instruction. A conversation begins at either node 20 or 22 and follows the arrow links until it reaches one of the end nodes 24, 26, 28 or 30.

Suppose that the student has a session with a live instructor scheduled for twenty minutes from now. The CSP must choose content to fill the twenty minute session. It might target the conversation comprised of the node sequence 20-32-34-36-38-28 for presentation during the live session. In order for the student to successfully complete the live conversation, he will have to be able to say the utterances in the nodes labeled 20-32-34-36-38-28. Suppose that the student trains on each of these utterances individually, performs successfully in software training, and then subsequently succeeds in performing the same conversation in the live session.

The student now has demonstrated knowledge of and ability to produce the utterances in nodes 20-32-34-36-38-28. This also means that the user knows and can produce the utterances in all nodes containing the same letter as any of nodes 20-32-34-36-38-28. In particular, the user knows all of the utterances necessary to perform the complete conversation represented by the node sequence 20-40-42-44-24. The instructor's utterances in that conversation will differ from the ones in the sequence 20-32-34-36-38-28, which means that the student will have to understand the instructor's utterances successfully in order to complete the conversation. The CSP might select the 20-40-42?-44-24 sequence as a second conversation to try in the live session, because it is a novel experience that does not require any additional training in order to be completed.

The next day, the student returns, and the CSP must select content for the student to train and perform on. The CSP determines that by training on node 46, which includes the user utterance represented by the letter C, the user would then be able to perform the additional conversation 20-46-34-36-38-28.

The Student later performs conversation sequence 20-46-34-36-38-28 in live session. The instructor notices that the user performs poorly on nodes 36 and 38. Thus nodes containing responses E and B are now unavailable, so there are no complete conversations available. Accordingly, the CSP chooses to remediate those utterances before introducing new content.

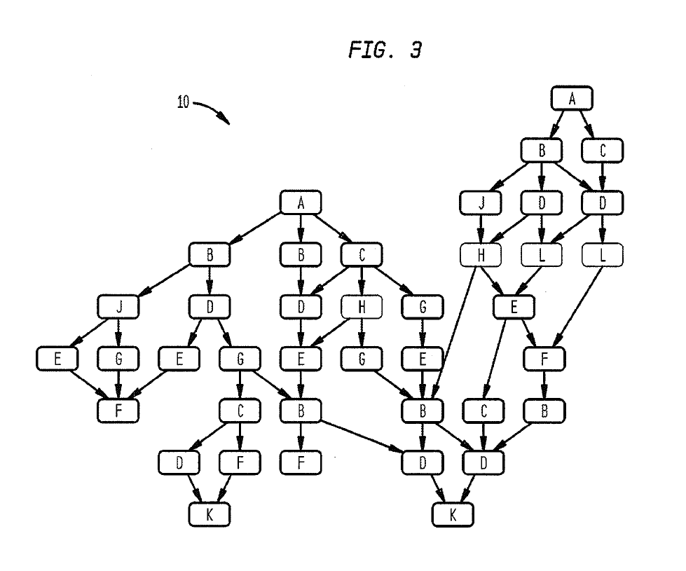

After the remediation is complete, the CSP introduces utterances C, G and K. At this point, nearly all of the conversations reachable from node 1 are available for performance in training or live. FIG. 3 shows the training state of the student after this training. The trained utterances have a heavy outline. At this point, the CSP has many options available. It can continue to introduce new content (utterances H and L). It can present conversations that the user is prepared for, but has not yet seen. It can present conversations that the user has already performed.

Generally, the system may alter its path at any of the nodes in which plural output directions are available, so that the direction taken depends upon a variety of factors such as the skill of the user, the availability of a live instructor, and/or other items discussed above. See for example, the criteria set forth in paragraph above.

As an example, if the current session had only a few minutes left and the CSP observes that the student is exhibiting poor ability in one of the nodes, it might switch him to another path, where it predicts that the student will exhibit higher ability and complete his lesson within the allotted time.

Further, the CSP preferably knows in advance the potential content of the live instruction. For example, there may be three alternatives for live instruction, and preferably, each of them is similar to or depends upon a path through the graph used during computerized instruction. As the CSP also knows when that live instruction will occur, it can easily estimate which paths through the graph can be learned in an amount time appropriate so that the user will be ready just in time for the live instruction. In this process, the system preferably may take into account one or more of the factors described above, such as student ability, estimated time to learn a particular node in the graph, etc.

For example, and referring to FIG. 1, the system starting at 20 can teach the user A-B-D-E-B-F, or A-C-H-G, or A-B-J-E-F, among others. The live instructor, in a session to follow, may teach the user a selected one of three or four possible ones of these paths, or may select from three or four lessons that are similar too, or otherwise heavily based upon these paths. Thus, the live instruction assumes working knowledge of specific paths represented in the graph.

Some of the paths may be unfeasible to teach in time. For example, with respect to the central path down the center of FIG. 1, the student may know A, B, D, and E, but not F. If the average amount of time it takes for a student to learn F is longer than the amount of time until the next live session, then the system would not pick the central path A-B-D-E-B-F because the likelihood is that the student would not be proficient enough in this path when it was time for the live instruction. In this case, the system would select a different path that corresponds potentially to a different live session. In short, by estimating based upon parameters unique to the user and/or system wide parameters such as average learning time for a node, the system may choose from among numerous paths through the graph for ensuring that the computer instruction is matched with the live instruction, such that the user is prepared at the right time for the correct live lesson.

Although the nodes have been presented as comprising the examples above, the content of each node is not limited thereby. For example, the nodes may include any sequence of utterances, and may even be variable themselves and contain selection logic such as that described herein. That is, a node may itself include a graph and various possibilities for different teaching paths through that node, such that when the node is invoked, parameters are analyzed and logic invoked to determine what content should be included in that node, preferably using techniques similar to those above.

Moreover, the system can make selections for nodes to teach based upon not only an upcoming live session, but based upon other computer and live sessions to be executed over a period of days, weeks, or months.

Although a preferred embodiment of the invention has been disclosed for illustrative purposes, those skilled in the art will appreciate that many additions, modifications and substitutions are possible, without departing from the scope and spirit of the invention as defined by the accompanying claims.

1. A method for creating the content of an instructor-student interaction set in an automated teaching system, comprising the step of structuring the interactions in a graph-based arrangement in which student interaction responses are a set of interconnected nodes arranged in a directed graph.

2. The method of claim 1 further comprising the step of creating node groups which are to receive specialized processing.

3. The method of claim 2, wherein the node groups include at least one of:
a serial group in which the constituent nodes are processed in the same sequence whenever the group is encountered;
an AND-group in which all of the constituents are processed whenever the group is encountered; and
an XOR-group in which only one of the constituents is processed whenever the group is encountered.

4. The method of claim 3 wherein the constituents of the AND-group are processed in random order.

5. The method of claim 2 further comprising the step of defining one of the nodes as an optional node for which processing is inhibited upon the occurrence of predefined conditions.

6. The method of claim 1 further comprising the step of defining one of the nodes as an optional node for which processing is inhibited upon the occurrence of predefined conditions.

7. (canceled)

8. The method of claim 1 further comprising the steps of defining a group of tasks for presentation to a student in an interaction, determining the student's likelihood of success in each of the tasks in view of his demonstrated ability, and presenting one of the tasks to the student, based on his likelihood of success.

9. The method of claim 1 further comprising the step of presenting a prompt to a student based upon the anticipated need for the subject matter in a future interaction sequence.

10. The method of claim 1 further comprising the step of using the teaching system to control the presentation of a live instructor in an instructor-student interaction sequence, the instructor's communications being controlled, at least initially, to conform substantially to an interaction sequence previously presented by the teaching system.

11. The method of claim 1 further comprising the steps of predicting the knowledge, ability or maximum rate of content mastery by the student based on previous performance and presenting an interaction sequence to the student based on one of the predictions.

12. An automated teaching system containing stored data representing the content of an instructor-student interaction set, the data being structured in a graph-based arrangement in which student interaction responses are a set of interconnected nodes arranged in a directed graph, a node having more than one predecessor level node branching into it.

13. (canceled)

14. The system of claim 12, wherein the data is structured to include node groups configured to receive specialized processing, the node groups include at least one of:
a serial group in which the constituent nodes are processed in the same sequence whenever the group is encountered;
an AND-group in which all of the constituents are processed whenever the group is encountered; and
an XOR-group in which only one of the constituents is processed whenever the group is encountered.

15. The system of claim 14 wherein the constituents of the AND-group are processed in random order.

16. (canceled)

17. The system of claim 12, wherein a student response in the data is structured as a template statement with a gap that may contain variable information.

18. The system of claim 12, wherein a group of tasks for presentation to a student is defined, the tasks related to an instructor prompt in an interaction, the system further comprising a content selection processor which determines the student's likelihood of success in each of the tasks in view of his demonstrated ability, and presents one of the tasks to the student, based on his likelihood of success.

19. The system of claim 12, further comprising a content selection processor which presents an instructor prompt to a student based upon the anticipated need for the subject matter in a future interaction sequence.

20. The system of claim 12, further comprising a content selection processor which controls the presentation of a live instructor in an instructor-student interaction sequence, the instructor's communications being controlled, at least initially, to conform substantially to an interaction sequence previously presented by the teaching system.

21. (canceled)

22. A method of selecting specific nodes to teach in a computer learning system, comprising the steps of arranging the nodes in a graph to form paths, arranging for live instruction, and selecting nodes to teach by the computer learning system by matching paths in the computer learning system to paths to be taught in the live instruction or any future instruction.

23. The method of claim 22 wherein said matching includes at least one system wide parameter and at least one user specific parameter.

24. The method of claim 23 wherein said parameters are selected from a group including:
projected amount of time left in current computer training session;
projected amount of time left in overall training for the current training set;
observed knowledge of the student;
predicted knowledge of the student;
observed ability of the student;
predicted ability of the student;
available content in upcoming live instruction;
predicted maximum rate of content mastery by student; and
average learning time among users for a particular node.

25-28. (canceled)
